(19) United States
(12) Patent Application Publication
(10) Pub. No.: US 2002/0036883 A1
(43) Pub. Date: Mar. 28, 2002

(54) Activated carbon for electric double layer capacitor

(76) Inventors: Minoru Noguchi, Saitama (JP); Naohiko Oki, Saitama (JP); Manabu Iwaida, Saitama (JP); Tomoyuki Aida, Fukushima (JP); Aisaku Nagai, Fukushima (JP); Yukio Ichikawa, Fukushima (JP)

Correspondence Address: DINSMORE & SHOHL, LLP, 1900 CHEMED CENTER, 255 EAST FIFTH STREET, CINCINNATI, OH, 45202, US

(21) Appl. No.: 09/738,362

(22) Filed: Dec. 15, 2000

(30) Foreign Application Priority Data
Dec. 17, 1999 (JP) 358427/1999

(51) Int. Cl. C01B 31/00; H01G 9/00

(52) U.S. Cl. 361/502; 423/447.1

(57) ABSTRACT

An activated carbon for electric double layer capacitor whose rate of FS (filling swing) in an αₛ-plot by the nitrogen adsorption method is at most 27 cm³/g STP. An activated carbon electrode formed with the activated carbon. An electric double layer capacitor equipped with the activated carbon electrodes as polarizable electrodes and having excellent durability.

### FIELD OF THE INVENTION

The present invention relates to an activated carbon for electric double layer capacitor having excellent durability, and more particularly to an activated carbon for electric double layer capacitor, which permits providing an electric double layer capacitor exhibiting a high electrostatic capacity and a low resistance and excellent in both retention of electrostatic capacity and retention of resistance after a durability test when polarizable electrodes of the electric double layer capacitor are constructed by the activated carbon. The present invention also relates to activated carbon electrodes formed with the activated carbon exhibiting such excellent durability as described above, and an electric double layer capacitor equipped with the activated carbon electrodes as polarizable electrodes.

### BACKGROUND OF THE INVENTION

An electric double layer capacitor is characterized by large capacity and long life, possible quick charge, easy charge and discharge, excellent cycle properties compared with a secondary battery and lower price than an Ni—Cd battery having the highest reliability among secondary batteries. Therefore, its functional applications are expected as a new energy device in many fields. The electric double layer capacitor is investigated so as to apply it to a high power field such as auxiliary power source for electric cars and hybrid cars, including a low power field such as a back-up power source for electronic instruments. Therefore, there is a demand for development of higher-performance polarizable electrodes.

The electric double layer capacitor is a large-capacity capacitor making good use of a capacity stored in an electric double layer occurred at an interface between polarizable electrodes and an electrolyte. The polarizable electrodes are required to have large specific surface area and high bulk density, be electrochemically inert and have low electrical resistance. An attention has been attracted to activated carbons as electrode materials satisfying these requirements, and an electric double layer capacitor equipped with polarizable electrodes formed with such an activated carbon has been already developed.

As activated carbons used for forming polarizable electrodes, it has been proposed to use activated carbons obtained from various carbonaceous raw materials such as coconut shells, petroleum pitch, petroleum coke, phenol resins, polyvinylidene chloride resins and polyvinyl chloride resins. Activated carbon is generally produced by carbonizing a carbonaceous raw material and then activating the carbonized product to make it porous. The activated carbon has countless minute holes called pores and a large surface area (also referred to as specific surface area), and the large surface area is utilized as a polarizable electrode.

As described above, the activated carbon has properties suitable for used as a material for polarizable electrodes of the electric double layer capacitor. However, the activated carbons proposed heretofore have not been sufficient in durability when they have been formed into polarizable electrodes. More specifically, an electric double layer capacitor equipped with polarizable electrodes formed with the conventional activated carbon has involved a problem that the performance is deteriorated due to lowering of electrostatic capacity, rise in resistance and the like during use even when initial properties thereof are good. Polarizable electrode materials for electric double layer capacitors are required to cause no electrochemical reaction with an electrolyte or electrolytic solvent and at the same time undergo no oxidation-reduction reaction by itself even when the resulting electrodes are polarized in an operating voltage region. The electric double layer capacitor is always kept in a voltage-applied state when it is installed as a back-up power source into an instrument. Therefore, when such a reaction is caused even to a slight extent, the performance is markedly deteriorated upon long-term use.

The activated carbon is known to affect the properties of an electric double layer capacitor by its pore size distribution, pore volume and surface physical properties such as amount of a functional group on the surface thereof when it is used as polarizable electrodes of the electric double layer capacitor. As a method for improving long-term reliability on application of voltage, it has heretofore been proposed to decrease the amount of a functional group on the surface of an activated carbon [Hiratsuka et al., DENKI KAGAKU, Vol. 59, No. 7, pp. 607-613 (1991)]. More specifically, according to this literature, as a measure of the amount of the functional group on the surface, attention is paid to the content of oxygen in the activated carbon by elementary analysis, and it is elucidated that a polarizable electrode formed from an activated carbon lower in oxygen content becomes less in performance deterioration by application of voltage. Similarly, there have been proposed methods for improving the long-term reliability of an electric double layer capacitor by using polarizable electrodes formed from a carbon material reduced in the concentration of an acid functional group on the surface thereof (Japanese Patent Publication No. 56827/1994) or polarizable electrodes formed from an activated carbon treated with a reducing agent to remove oxides present on the surface thereof (Japanese Patent Application Laid-Open Nos. 101980/1993 and 201674/1995).

Even when the polarizable electrodes formed from these activated carbons improved by the prior art are used, however, the durability of the electric double layer capacitors yet remains insufficient, and so such electric double layer capacitors have involved a problem that the performance is deteriorated due to lowering of electrostatic capacity and rise in resistance during use for a long period of time. Besides, the durability cannot be improved by a method of merely adjusting the specific surface area of an activated carbon. Accordingly, there is a demand for still greater improvement in activated carbon under a more increasing demand for development of a higher-performance electric double layer capacitor with the years.

### OBJECTS AND SUMMARY OF THE INVENTION

It is an object of the present invention to provide an activated carbon for electric double layer capacitor having excellent durability.

Another object of the present invention is to provide an activated carbon electrode formed with this activated carbon.

A further object of the present invention is to provide an electric double layer capacitor equipped with the activated carbon electrodes as polarizable electrodes and markedly improved in durability.

The present inventors have carried out an extensive investigation with a view toward achieving the above objects. As a result, it has been found that with attention to FS (filling swing) in αₛ-plots by the nitrogen adsorption method for activated carbons, polarizable electrodes are formed with an activated carbon having the FS of a certain value or less, whereby an electric double layer capacitor, which sufficiently retain the initial electrostatic capacity and resistance thereof even upon long-term use and is markedly improved in durability, can be provided. The present invention has been led to completion on the basis of this finding.

According to the present invention, there is thus provided an activated carbon for electric double layer capacitor whose rate of FS (filling swing) in an αₛ-plot by the nitrogen adsorption method is at most 27 cm³/g STP.

According to the present invention, there is also provided an activated carbon electrode formed with the activated carbon.

According to the present invention, there is further provided an electric double layer capacitor equipped with the activated carbon electrodes as polarizable electrodes.

### BRIEF DESCRIPTION OF THE DRAWINGS

FIG. 1 diagrammatically illustrates the relationship between αₛ-plots by the nitrogen adsorption method and the rate of FS (filling swing).

FIG. 2 diagrammatically illustrates the relationship between the retentions of electrostatic capacity and resistance of electric double layer capacitors obtained in Examples and Comparative Example and the rate of FS.

FIG. 3 is a cross-sectional view illustrating an exemplary single cell type electric double layer capacitor.

### DETAILED DESCRIPTION OF PREFERRED EMBODIMENTS

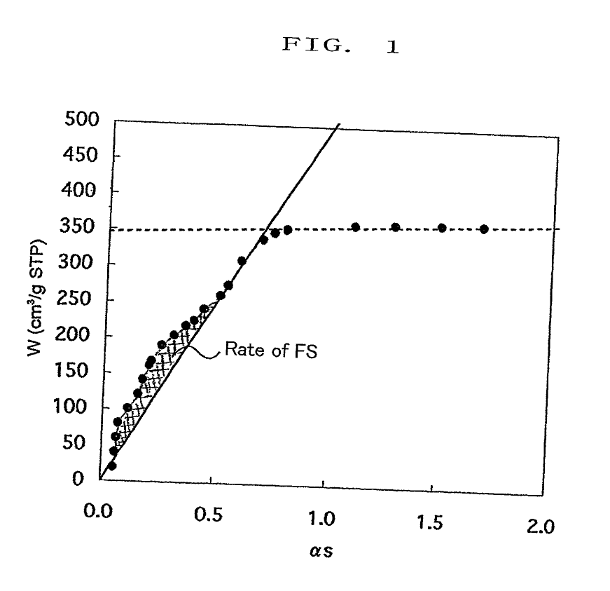

It is essential for the activated carbon according to the present invention to have a rate of FS (filling swing) of at most 27 cm³/g STP in an αₛ-plot by the nitrogen adsorption method. The rate of FS in the αₛ-plot by the nitrogen adsorption method in the present invention is defined as an area of a deviation from a line representing the total surface area and passing through the origin in positions below αₛ=1.0 when nitrogen αₛ-plots for activated carbons are constructed as illustrated in FIG. 1 in accordance with the method disclosed in Setoyama et al., Carbon Vol. 36, No. 10, pp. 1459-1467 (1998).

According to the gas adsorption method, the information as to the specific surface area, pore volume and the like of a porous carbon material is generally obtained. The adsorption measurement is carried out under conditions of a fixed temperature, and thereby the relationship between equilibrium pressures and amounts adsorbed called an adsorption isotherm [axis of ordinate =amount adsorbed, axis of abscissa =relative pressure (P/P₀)] is determined. The measurement is generally performed at a boiling point of molecules to be adsorbed. In the case of adsorption of nitrogen molecules typical as a probe, the measurement is carried out at 77 K.

A value obtained by dividing an amount adsorbed at each relative pressure by the amount adsorbed at P/P₀ =0.4 in the standard isotherm is defined as an as value. When the P/P₀ indication is converted into αₛ indication, the adsorption isotherm of a sample can be compared with the standard isotherm. When an amount adsorbed at each measurement point of the isotherm to be compared is plotted against an αₛ value corresponding to each P/P₀, an αₛ-plot can be constructed.

The total surface area is found from a slope of the line from the origin as illustrated in FIG. 1. An external surface area is found from a slope of an extrapolated line (dotted line) from a high-pressure area. In FIG. 1, there is a region in which measuring points deviate from the extrapolated line. This comes from enhanced surface-molecule interaction or intermolecular interaction in pores and is classified into F-swing (FS) and condensation swing (C-swing; not appear in the case of FIG. 1). In the present invention, attention is paid to FS shown in FIG. 1.

When the axis of ordinate in the αₛ-plot is indicated by the amount adsorbed, cm³/g STP, the unit of the rate of FS is given by cm³/g STP because the axis of abscissa, αₛ is dimensionless. In the above literature, FS is described as being created by a strong molecule adsorption field from very small pore surfaces and mainly dominated by pores having a pore size of at most 0.7 nm. Accordingly, it is considered that when polarizable electrodes are formed with an activated carbon having a rate of FS higher than 27 cm³/g STP, an electrolytic solvent, electrolytes (ions) and the like are strongly bound in pores forming a strong molecule adsorption field, and so a probability of causing reactions such as oxidation and reduction of the electrode material itself becomes high, resulting in an electric double layer capacitor having poor durability. On the other hand, it is considered that an activated carbon having a rate of FS not higher than 27 cm³/g STP has less pores forming the strong molecule adsorption field, and so its reactions with the solvent, ions and the like is lessened, resulting in an electric double layer capacitor having excellent durability.

In the activated carbon according to the present invention, the rate of FS is preferably at most 25 cm³/g STP, more preferably at most 23 cm³/g STP. No particular limitation is imposed on the lower limit of the rate of FS. However, the activated carbon according to the present invention can exhibit good results when the rate of FS falls within a range of often 10 to 25 cm³/g STP, particularly 15 to 23 cm³/g STP. The STP as used herein means a standard state (temperature=0° C., pressure=1 atm).

As a raw material for the activated carbon, may be used, for example, a carbonaceous raw materials such as a coconut shell, petroleum pitch, coal pitch, petroleum coke, phenol resin, polyvinylidene chloride resin or polyvinyl chloride resin. As a process for producing the activated carbon, may be mentioned a process comprising carbonizing and/or activating a carbonaceous raw material. Examples of an activating method, may be mentioned a gas activating method and a chemical activating method.

As a carbonizing method, may be mentioned a method in which a raw material for activated carbon is calcined at a relatively low temperature of 300 to 850° C. using an inert gas such as nitrogen gas, carbon dioxide, helium, argon, xenon, neon, carbon monoxide, a combustion exhaust gas or a mixture thereof. In the gas activating method, the raw material for activated carbon is generally carbonized and then subjected to a catalytic reaction with a mixed gas of steam, carbon monoxide, oxygen and combustion exhaust gas to activate it. The gas activating method is suitable for coconut shells, pitch materials and the like.

In the chemical activating method, the raw material for activated carbon is carbonized and/or activated in the presence of zinc chloride, sodium hydroxide, potassium hydroxide, calcium hydroxide, boric acid, phosphoric acid, sulfuric acid, hydrochloric acid or the like. The carbonization and/or activation is generally conducted under conditions of about 400 to 1,100° C. However, the temperature conditions and the like vary according to the kind of the chemical used. For example, when the carbonization and/or activation is conducted with zinc chloride, it is performed at a temperature not higher than a boiling point (732° C.) of zinc chloride. It is preferable to carbonize and activate a polyvinylidene chloride resin with zinc chloride.

Only the carbonization may be performed according to the kinds of the raw material for activated carbon and the carbonizing and activating methods. However, it is generally preferable to conduct both carbonization and activation. After the carbonizing and activating treatment, the resultant activated carbon may also be subjected to a secondary or still higher activating treatment as needed.

No particular limitation is imposed on the raw material, production process and the like of the activated carbon according to the present invention so far as the rate of FS thereof is at most 27 cm³/g STP. However, the rate of FS can be controlled within the desired range, for example, by selecting any of such conditions as using a polyvinylidene chloride and zinc chloride, presetting the amount of zinc chloride used rather smaller than the resin, adjusting the amount of water, presetting the carbonizing and activating temperature to a higher temperature in the vicinity of the boiling point of zinc chloride and combining these conditions. However, the present invention is not limited to activated carbons obtained by such specific processes.

No particular limitation is imposed on the surface oxygen content in the activated carbon according to the present invention. However, it is preferably controlled to generally at most about 5%, more preferably at most about 4.5% from the viewpoint of durability. In order to achieve far excellent durability in the activated carbon according to the present invention, the surface oxygen content is preferably controlled to lower than 3%. The surface oxygen content in the activated carbon can be determined by the X-ray photoelectron spectroscopy. It is particularly preferable to control the surface oxygen content in the activated carbon to at most 2%. No particular limitation is imposed on the lower limit of the surface oxygen content. However, it is generally about 0.1%. Examples of a method for lessening the surface oxygen content in the activated carbon include a method in which a carbonized product obtained by carbonization and/or activation is treated at a high temperature in a nitrogen gas stream.

The activated carbon according to the present invention preferably has a specific surface area of 500 to 5,000 m₂/g, preferably 800 to 4,000 m²/g as determined by nitrogen adsorption in accordance with the BET method from the viewpoint of electrostatic capacity. When the specific surface area falls within a range of often 1,000 to 2,000 m²/g particularly 1,100 to 1,600 m₂/g good results can be yielded.

The activated carbon electrode according to the present invention is formed with the activated carbon according to the present invention. In order to produce the activated carbon electrode, it is only necessary to kneading the activated carbon together with a binder and optional additives such as conductive acetylene black and shape the kneaded product into the prescribed electrode form. Examples of the binder include polytetrafluoroethylene (PTFE) and polyvinylidene fluoride (PVDF). More specifically, as examples of a production process of the activated carbon electrode, may be mentioned a process in which a solvent is added to a mixture composed of an activated carbon, a conductive material, a binder, etc. to prepare a slurry mixture, and the slurry mixture is applied to a current collector by coating or dipping and then dried (for example, Japanese Patent Application Laid-Open No. 64765/1998), and a process in which a sheet obtained by adding a solvent to a mixture composed of an activated carbon, a conductive material, a binder insoluble in the solvent, etc. to conduct kneading and molding and drying the molded product is bonded to the surface of a current collector through a conductive adhesive or the like, and the conductor is then pressed and dried by heat treatment.

No particular limitation is imposed on the electric double layer capacitor according to the present invention so far as it is an electric double layer capacitor equipped with the activated carbon electrodes according to the present invention as polarizable electrodes. Specific examples of the electric double layer capacitor include that of a structure illustrated in FIG. 3. FIG. 3 is a cross-sectional view illustrating an exemplary single cell type electric double layer capacitor. This electric double layer capacitor is constructed by tightly enclosing a structure that a separator 2 is held between 2 polarizable electrodes 1, 1 and the resultant laminate is further held between collecting plates (collecting electrodes) 3, 3, into an electrolytic solution-containing case 4, 4 through a packing 5. The electrolytic solution may be either a nonaqueous solvent type or an aqueous type. In the nonaqueous solvent type, an electrolyte dissolved in an organic solvent is used. As a typical example of the nonaqueous solvent type electrolytic solution, may be mentioned a propylene carbonate solution of (C₂H₅)₄NBF₄.

The activated carbon electrodes formed with the activated carbon according to the present invention are particularly suitable for use as polarizable electrodes for electric double layer capacitors and exhibit excellent durability. More specifically, an electric double layer capacitor equipped with the activated carbon electrodes according to the present invention as polarizable electrodes can exhibit a retention of electrostatic capacity of preferably 80 to 110%, more preferably 85 to 105% and a retention of resistance of preferably 90 to 125%, more preferably 95 to 120% in a durability test at a temperature of 70° C. and a voltage of 2.5 V for 12 hours. Particularly preferably, the electric double layer capacitor equipped with the activated carbon electrodes according to the present invention as polarizable electrodes can exhibit high durability as demonstrated by both retention of electrostatic capacity and retention of resistance of 95 to 105%.

### ADVANTAGES OF THE INVENTION

According to the present invention, there are provided activated carbons for electric double layer capacitors, which permit providing electric double layer capacitors exhibiting a high electrostatic capacity and a low resistance and excellent in both retention of electrostatic capacity and retention of resistance after a durability test when polarizable electrodes of the electric double layer capacitors are constructed by the activated carbons. According to the present invention, there are also provided activated carbon electrodes formed with such an activated carbon, and electric double layer capacitors equipped with the activated carbon electrodes as polarizable electrodes.

### EMBODIMENTS OF THE INVENTION

The present invention will hereinafter be described more specifically by the following Examples, and Comparative Example. However, the present invention is not limited by these examples.

The evaluation of properties were conducted in accordance with the following respective methods.

(1) Rate of FS

A nitrogen adsorption isotherm at 77 K of each activated carbon sample was determined by means of a high speed specific surface area•pore size distribution measuring apparatus [ASAP2000 manufactured by Shimadzu Corporation], an αₛ-plat is constructed from the adsorption isotherm thus obtained in accordance with the method disclosed in Carbon, Vol. 36, No. 10, pp. 1459-1467 (1998), and the rate (cm³/g STP) of FS (filling swing) was found as an area of a deviation from a line representing the total surface area and passing through the origin as illustrated in FIG. 1.

(2) Surface Oxygen Ccontent

The surface oxygen content in each activated carbon sample was determined by the X-ray photoelectron spectroscopy.

(3) Durability

Polarizable electrodes were produced with each activated carbon sample, and an electric double layer capacitor equipped with the polarizable electrodes was then fabricated to measure its electrostatic capacity and resistance. With respect to the measurements of the electrostatic capacity and resistance, the respective initial values and values after treated at a. temperature of 70° C. and a voltage of 2.5 V for 12 hours were found to calculate out the respective retentions. Thee retentions (%) were expressed as [(Physical property value after treatment/Physical property value before treatment)×100]. A retention nearer 100% indicates better durability.

(4) Electrostatic Capacity

The total discharge energy (W•s) was found as an integral value of time of discharge energy (discharge voltage×electric current) from a discharge curve (discharge voltage-discharge time) of each electric double layer capacitor to determine the electrostatic capacity in accordance with the following equation:

Electrostatic capacity (F)=[2×Total discharge energy(W•s)]/[Discharge stating voltage(V)]²

(5) Resistance

A line was drawn between 2 points at which the voltage was reduced to 75% and 50% of the discharge starting voltage in the above discharge curve (discharge voltage-discharge time) to determine a potential by extrapolating it to zero minute from the starting of discharge. The potential determined by the extrapolation was subtracted from the discharge starting voltage 2.3 V to regard the value thus obtained as voltage drop upon starting of discharge. The voltage drop was then divided by a discharge current to regard the value thus obtained as a resistance value.

(6) Specific Surface Area

Vm was determined by a single-point determination (relative pressure x=0.3) by nitrogen adsorption at a liquid nitrogen temperature using an approximate expression: Vm=1/[V(1 −x)] derived from the BET equation to find the specific surface area of each activated carbon sample by nitrogen adsorption in accordance with the BET method from the following equation:

Specific surface area=4.35×Vm(m²/g) wherein Vm is an amount (cm³/g) adsorbed necessary for forming a monomolecular layer on the surface of the sample, V is a found amount (cm³/g) adsorbed, and x is a relative pressure.

More specifically, the amount of nitrogen adsorbed on the activated carbon sample at a liquid nitrogen temperature was measured by means of Flow Sorb II 2300 manufactured by MICROMERITICS Co. in the following manner. An activated carbon ground to a particle size of about 5 to 50 μm is charged into a sample tube, and the sample tube is refrigerated to −196° C. while passing helium gas containing nitrogen gas at a concentration of 30 mol % through, thereby causing nitrogen to be adsorbed on the activated carbon. The sample tube is then heated to room temperature. The amount of nitrogen separated out of the sample at this time is measured by a thermal conductivity type detector to regard it as an amount V adsorbed.

### Example 1

Polyvinylidene chloride powder, zinc chloride and water were mixed in proportions of 100/40/10 in terms of a weight ratio, and the resultant mixture was then heated to 730° C. at a heating rate of 100° C./min. The mixture was held at 730° C. for 12 hours to conduct the carbonization and activation of the polyvinylidene chloride powder. The carbonized product thus obtained was washed with water and then dried at 130° C. The dried carbonized product was ground to a particle size of at most 150 mesh to obtain a powdered activated carbon.

The activated carbon thus obtained was used to produce activated carbon electrodes and an electric double layer capacitor in the following manner.

(i) Drying of Activated Carbon

The activated carbon was dried at 150° C. for 1 minute in a vacuum dryer and then placed in a sample bottle to seal a lid by winding a sealing tape around the lid. This sample bottle was placed in a silica gel-containing desiccator to cool the activated carbon to ordinary temperature (in about 15 minutes).

(ii) Kneading of Activated Carbon

Ten parts by weight of conductive acetylene black was ground in a mortar. The dried activated carbon was taken out of the sample bottle, and 80 parts by weight thereof were immediately weighed out and placed in the mortar to well knead it with the conductive acetylene black. After 10 parts by weight of polytetrafluoro-ethylene (PTFE) powder were then placed in the mortar and stirred, the resultant mixture was kneaded by a pestle to prepare the mixture into a gum-like product. This gum-like product was wrapped with paper used for wrapping of powdered medicine and left to stand for 1 hour in the air to prepare a sample for electrode.

(iii) Production of Activated Carbon Electrode

The gum-like sample for electrode was chopped with a razor blade, charged into a circular mold and subjected to pressure molding for 5 minutes under a pressure of 200 MPa, thereby producing an activated carbon electrode. The thickness of the activated carbon electrode was measured by a thickness meter to calculate out the volume thereof.

(iv) Fabrication of Electric Double Layer Capacitor

A conductive paste composed of a mixture of conductive carbon black, hydroxymethyl cellulose and water was applied to one side of each of 2 aluminum-made collecting plates. While the conductive paste layer remained a semi-dried state, the activated carbon electrode was struck thereon. Laminates composed of the collecting plate/activated carbon electrode were prepared in the above-described manner. A glass fiber filter (GA-200, product of ADVANTEC Co.) was. used as a separator and held between the activated carbon electrode sides of the two laminates. This sandwich structure was incorporated into a PTFE cell. This cell was dried at 150° C. for 3 hours in a vacuum dryer and then allowed to cool in a glove box having a dew point of −90° C. or lower. An electrolytic solution was then added into the PTFE cell to assemble a single cell type electric double layer capacitor. As the electrolytic solution, was used a (C₂H₅)₄NBF₄/propylene carbonate (1 mol/L) solution.

The evaluation results of properties are shown in Table 1.

### Example 2

A powdered activated carbon was obtained in the same manner as in Example 1 expect that after the carbonized product was ground to a particle size of at most 150 mesh in Example 1, the ground product was treated at 700° C. for 2 hours in a nitrogen gas stream. The activated carbon thus obtained was used to produce activated carbon electrodes and an electric double layer capacitor in the same manner as in Example 1 to evaluate their properties. The results are shown in Table 1.

### Example 3

Petroleum pitch was oxidized with air at 260° C. for 1 hour and then held at 500° C. for 1 hour in a nitrogen gas stream to carbonize the pitch, and the carbonized product was then activated with steam of 900° C. The carbonized product thus obtained was ground to a particle size of at most 150 mesh, and the ground product was treated at 700° C. for 2 hours in a nitrogen gas stream to obtain a powdered activated carbon. The activated carbon thus obtained was used to produce activated carbon electrodes and an electric double layer capacitor in the same manner as in Example 1 to evaluate their properties. The results are shown in Table 1.

### Example 4

Polyvinylidene chloride powder, zinc chloride and water were mixed in proportions of 100/100/5 in terms of a weight ratio, and the resultant mixture was then heated to 730° C. at a heating rate of 100° C./min. The mixture was held at 730° C. for 12 hours to conduct the carbonization and activation of the polyvinylidene chloride powder. The carbonized product thus obtained was washed with water and then dried at 130° C. The dried carbonized product was ground to a particle size of at most 150 mesh, and the ground product was treated at 700° C. for 2 hours in a nitrogen gas stream to obtain a powdered activated carbon. The activated carbon thus obtained was used to produce activated carbon electrodes and an electric double layer capacitor in the same manner as in Example 1 to evaluate their properties. The results are shown in Table 1.

### Comparative Example 1

Polyvinylidene chloride powder and zinc chloride were mixed in proportions of 100/100 terms of a weight ratio, and the resultant mixture was then heated to 730° C. at a heating rate of 100° C./min. The mixture was held at 730° C. for 12 hours to conduct the carbonization and activation of the polyvinylidene chloride powder. The carbonized product thus obtained was washed with water and then dried at 130° C. The dried carbonized product was ground to a particle size of at most 150 mesh, and the ground product was treated at 700° C. for 2 hours in a nitrogen gas stream to obtain a powdered activated carbon. The activated carbon thus obtained was used to produce activated carbon electrodes and an electric double layer capacitor in the same manner as in Example 1 to evaluate their properties. The results are shown in Table 1.

TABLE 1

| | Properties of activated carbon | | | | | | | | |
|---|---|---|---|---|---|---|---|---|---|
| | | | Specific | Evaluation results of durability test | | | | | |
| | Rate of | Oxygen | surface | | | | | Retention of | Retention of |
| | Fs | content | area | Initial value | | After test | | capacity | resistance |
| | cm³/g STP | % | m²/g | F | Ω | F | Ω | % | % |
| Ex. 1 | 18.4 | 4.1 | 1600 | 9.55 | 1.05 | 9.00 | 1.16 | 94 | 110 |
| Ex. 2 | 18.6 | 1.3 | 1570 | 9.52 | 1.08 | 9.49 | 1.11 | 100 | 103 |
| Ex. 3 | 17.1 | 1.5 | 1120 | 8.40 | 0.45 | 8.40 | 0.45 | 100 | 100 |
| Ex. 4 | 24.4 | 0.9 | 1580 | 13.35 | 0.45 | 11.69 | 0.53 | 88 | 118 |
| Comp. | 32.0 | 1.0 | 1610 | 15.08 | 1.89 | 5.77 | 2.78 | 38 | 147 |
| Ex. 1 | | | | | | | | | |

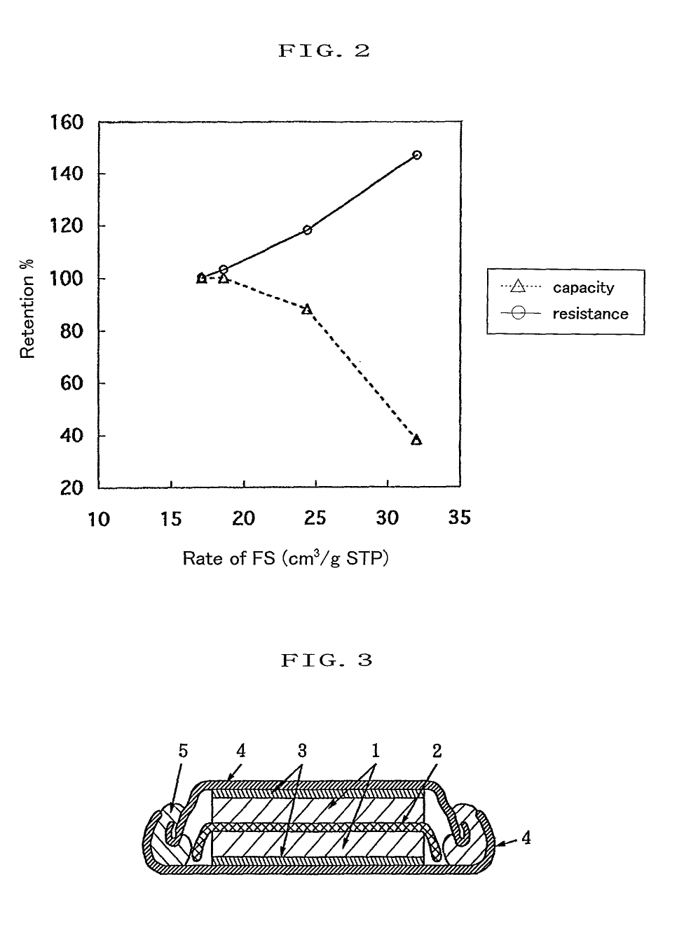

Among the experimental data shown in Table 1, the results of Examples 2 to 4 and Comparative Example 1, in which the oxygen content was low, are illustrated in FIG. 2. As shown in Table 1 and FIG. 2, the rate of FS and the retentions of physical properties have a very good corresponding relationship to each other. The activated carbon low in oxygen content, but high in rate of FS like Comparative Example 1 is poor in durability. On the other hand, the activated carbon relatively high in oxygen content, but low in rate of FS is excellent in durability. As described above, it is understood that activated carbons whose rate of FS is at most 27 cm³/g STP exhibit excellent durability.

1. An activated carbon for electric double layer capacitor whose rate of FS (filling swing) in an αₛ-plot by the nitrogen adsorption method is at most 27 cm³/g STP.

2. The activated carbon for electric double layer capacitor according to claim 1, wherein the rate of FS is at most 25 cm³/g STP.

3. The activated carbon for electric double layer capacitor according to claim 1, wherein the rate of FS is 10 to 25 cm³/g STP.

4. The activated carbon for electric double layer capacitor according to claim 1, wherein the oxygen content at the surface thereof is at most 5%.

5. The activated carbon for electric double layer capacitor according to claim 1, wherein the oxygen content at the surface thereof is lower than 3%.

6. The activated carbon for electric double layer capacitor according to claim 1, wherein the specific surface area is 500 to 5,000 m² /g as determined by nitrogen adsorption in accordance with the BET method.

7. The activated carbon for electric double layer capacitor according to claim 1, wherein the rate of FS is 10 to 25 cm³/g STP, the oxygen content at the surface thereof is 0.1 to 4.5%, and the specific surface area is 1,000 to 2,000 m²/g as determined by nitrogen adsorption in accordance with the BET method.

8. The activated carbon for electric double layer capacitor according to claim 1, which is obtained by carbonizing or activating or carbonizing and activating a carbonaceous raw material by a gas activating method or a chemical activating method.

9. The activated carbon for electric double layer capacitor according to claim 8, which is obtained by carbonizing and activating a polyvinylidene chloride resin by the chemical activating method making use of zinc chloride.

10. The activated carbon for electric double layer capacitor according to claim 8, which is obtained by carbonizing and activating coconut shell, petroleum pitch or coal pitch by the gas activating method.

11. An activated carbon electrode formed with an activated carbon whose rate of FS (filling swing) in an αₛ-plot by the nitrogen adsorption method is at most 27 cm₃/g STP.

12. The activated carbon electrode according to claim 11, which is obtained by shaping a mixture comprising the activated carbon, a conductive material and a binder into an electrode form.

13. An electric double layer capacitor equipped with activated carbon electrodes formed with an activated carbon, whose rate of FS (filling swing) in an αs-plot by the nitrogen adsorption method is at most 27 cm³/g STP, as polarizable electrodes.

14. The electric double layer capacitor according to claim 13, which is obtained by tightly enclosing a structure that a separator is held between 2 polarizable electrodes and the resultant laminate is further held between 2 collecting plates into an electrolytic solution-containing case.

15. The electric double layer capacitor according to claim 14, wherein the electrolytic solution is a nonaqueous solvent type electrolytic solution.

16. The electric double layer capacitor according to claim 13, which exhibits a retention of electrostatic capacity of 80 to 110% at a durability test at a temperature of 70° C. and a voltage of 2.5 V for 12 hours.

17. The electric double layer capacitor according to claim 13, which exhibits a retention of resistance of 90 to 125% in the durability test.

18. The electric double layer capacitor according to claim 13, wherein both retention of electrostatic capacity and retention of resistance in the durability test are 95 to 105%.
